(19) United States
(12) Patent Application Publication
(10) Pub. No.: US 2004/0072649 A1
(43) Pub. Date: Apr. 15, 2004

(54) Lubricant amount control apparatus and lubricant amount control method for power transmission mechanism

(76) Inventors: Tetsuya Kohno, Okazaki-shi (JP); Yuji Yasuda, Nishikamo-gun (JP)

Correspondence Address: KENYON & KENYON, 1500 K STREET, N.W., SUITE 700, WASHINGTON, DC, 20005, US

(21) Appl. No.: 10/681,094

(22) Filed: Oct. 9, 2003

(30) Foreign Application Priority Data
Oct. 10, 2002 (JP) 2002-297632
Dec. 2, 2002 (JP) 2002-350187

(51) Int. Cl. F16H 61/48

(52) U.S. Cl. 477/98; 477/54

(57) ABSTRACT

A lubricant amount control apparatus and a lubricant amount control method make a lubricant amount in an automatic transmission appropriate based on input energy and a lubricant temperature. The lubricant amount control apparatus includes an input energy calculating device which calculates energy input to a power transmission mechanism, a supply amount calculating device which calculates a supply amount of lubricant based on the input energy and a controller which controls a lubricating device for supplying lubricant such that the calculated supply amount of lubricant is supplied to the power transmission mechanism. With this configuration, it is possible to efficiently cool a component of a power transmission. Also, since an unnecessarily excessive amount of lubricant is not supplied, it is possible to suppress consumption of driving energy supplied by a power source for driving a hydraulic device.

### INCORPORATION BY REFERENCE

The disclosures of Japanese Patent Application No. 2002-297632 filed on Oct. 10, 2002 and Japanese Patent Application No. 2002-350187 filed on Dec. 2, 2002, including the specification, drawings and abstract are incorporated herein by reference in their entirety.

### BACKGROUND OF THE INVENTION

1. Field of the Invention

The invention relates to a technology for controlling a lubricant amount supplied to a power transmission mechanism of a vehicle. More particularly, the invention relates to a technology for making a lubricant amount appropriate based on energy input to a power transmission mechanism.

2. Description of the Related Art

When power of a vehicle is transmitted from a power source (an engine, a motor, or the like) to driving wheels, loss of power occurs in a power transmission mechanism. The power transmission mechanism is, for example, a transmission, a differential gear, or a transfer. The lubricant is supplied to the power transmission mechanism in order to suppress heat generation due to the loss of power.

In this case, if an unnecessarily excessive amount of lubricant is supplied, cooling efficiency may be decreased due to heat generation caused by agitation resistance of the lubricant. Also, if such an excessive amount of lubricant is supplied, an output of an oil pump is increased, friction loss of the oil pump is increased, and fuel consumption efficiency of a power source is decreased. Meanwhile, if a sufficient amount of lubricant is not supplied, a life span of a component of the power transmission mechanism such as a clutch, a gear, or a bearing, is reduced due to heat generation. Therefore, related art for solving these problems is disclosed.

Related art of the invention (first related art) relates to a lubricant amount control apparatus for supplying lubricant to a bearing which supports a main shaft. The lubricant amount control apparatus calculates a supply amount of lubricant based on a detected rotational speed of the main shaft. According to the lubricant amount control apparatus, the supply amount of lubricant is calculated based on the rotational speed of the main shaft and the calculated amount of lubricant is supplied, whereby the bearing of the main shaft is lubricated efficiently.

Also, another related art (second related art) relates to a lubricant amount control apparatus which makes it possible to obtain both high operation performance and high lubrication performance of an engine. The apparatus controls opening/closing of a control valve which opens/closes an air introducing portion which is connected to an oil suction passage of the oil pump or a crank case of the engine. According to the lubricant amount control apparatus, when the control valve is opened/closed based on an operation state of the engine, the suction/discharge resistance of the oil pump is increased and decreased. For example, when the vehicle is in a state where much engine output is not required, the air introducing portion is opened, and the oil pump's capability of sucking/discharging lubricant is decreased. At this time, a lubricant amount is decreased to an amount corresponding to the engine output. Meanwhile, when the vehicle is in the state where much engine output is required, the air introducing portion is closed, and the oil pump's capability of sucking/discharging lubricant is increased. At this time, the lubricant amount is increased to an amount corresponding to the engine output. In this manner, the lubricant amount control apparatus can supply, to the engine, the lubricant amount corresponding to the operation state of the engine.

Further related art (third related art) relates to a lubricant amount control apparatus including a lubricating device which recovers heat generated in a shifting mechanism of an automatic transmission using the lubricant. The apparatus detects an operating state of the shifting mechanism, determines the lubricant amount according to a heat generation amount in the shifting mechanism that is calculated based on the operating state of the shifting mechanism, and supplies the lubricant to the shifting mechanism according to the lubricant amount. According to the lubricant amount control apparatus, the heat generation amount in the shifting mechanism is calculated based on the operating state of the shifting mechanism, and the lubricant amount required for cooling the shifting mechanism is determined. When the lubricant amount thus determined is supplied to the shifting mechanism, an increase in a temperature of the shifting mechanism is suppressed. Also, since the lubricant of an amount required and sufficient for cooling is supplied, a decrease in the power transmission efficiency due to the agitation of the lubricant is prevented.

However, each of the control apparatuses according to the above related art has a problem that the lubricant amount in the power transmission mechanism cannot be made appropriate.

The lubricant amount control apparatus according to the first related art calculates the supply amount of lubricant according to the rotational speed of the main shaft. Therefore, there is a problem that the appropriate supply amount corresponding to the heat generation amount cannot be calculated.

The lubricant amount control apparatus according to the second related art controls the lubricant amount in the engine. Therefore, there is a problem that the apparatus as it is cannot be applied to the power transmission mechanism which has a configuration different from that of the engine.

The lubricant amount control apparatus according to the third related art supplies, to the shifting mechanism, the lubricant of an amount calculated based on the operating state of the shifting mechanism. Therefore, there is a problem that lubrication corresponding to the operating state of the power source is not performed, and the shifting mechanism cannot be appropriately cooled.

### SUMMARY OF THE INVENTION

A first aspect of the invention relates to a lubricant amount control apparatus for a power transmission mechanism. The lubricant amount control apparatus includes an input energy calculating device which calculates energy input to the power transmission mechanism; a supply amount calculating device which calculates a supply amount of lubricant based on the input energy; and a controller which controls a lubricating device for supplying lubricant such that the calculated supply amount of lubricant is supplied to the power transmission mechanism.

Also, a second aspect of the invention relates to a lubricant amount control method for a power transmission mechanism. The lubricant amount control method includes the steps of calculating energy input to a power transmission mechanism of a vehicle; calculating a supply amount of lubricant based on the input energy; and controlling a lubricating device for supplying lubricant such that the calculated supply amount of lubricant is supplied to the power transmission mechanism.

According to the above lubricant amount control apparatus and lubricant amount control method for a power transmission mechanism, the lubricant is supplied to the power transmission mechanism based on the energy input thereto. Therefore, it is possible to efficiently cool components of the power transmission mechanism (a gear, a bearing, and the like). Also, since an unnecessarily excessive amount of lubricant is not supplied, it is possible to suppress consumption of driving energy supplied by a power source (an engine, a motor, or the like) for driving a hydraulic device. Thus, the lubricant amount can be made appropriate based on the energy input to the power transmission mechanism.

A third aspect of the invention relates to a lubricant amount control apparatus for a power transmission mechanism. The lubricant amount control apparatus includes an input energy calculating device which calculates energy input to a power transmission mechanism; a lubricant temperature detecting device which detects a lubricant temperature; a supply amount calculating device which calculates a supply amount of lubricant based on the input energy and the lubricant temperature; and a controller which performs control such that the calculated supply amount of lubricant is supplied to the power transmission mechanism.

A fourth aspect of the invention relates to a lubricant amount control method for a power transmission mechanism. The lubricant amount control method includes the steps of calculating energy input to a power transmission mechanism of a vehicle; detecting a lubricant temperature; calculating a supply amount of lubricant based on the input energy and the lubricant temperature; and performing control such that the calculated supply amount of lubricant is supplied to the power transmission mechanism.

According to the lubricant amount control apparatus and the lubricant amount control method for a power transmission mechanism, the lubricant of an amount required and sufficient for cooling the power transmission device is supplied. Therefore, an unnecessarily excessive amount of lubricant is not supplied, and the accuracy of lubrication can be improved. Thus, the lubricant amount can be made appropriate based on the energy input to the power transmission.

### BRIEF DESCRIPTION OF THE DRAWINGS

The above mentioned embodiment and other embodiments, objects, features, advantages, technical and industrial significance of this invention will be better understood by reading the following detailed description of the exemplary embodiments of the invention, when considered in connection with the accompanying drawings, in which:

FIG. 1 is a control block diagram showing a lubricant amount control apparatus according to a first embodiment of the invention;

FIG. 2 is a diagram showing a drive train including an automatic transmission according to the first embodiment of the invention;

FIG. 3 is an operation table of engagement elements included in the automatic transmission according to the first embodiment of the invention;

FIG. 4 is a diagram showing a lubrication circuit according to the first embodiment of the invention;

FIG. 5 is a diagram showing transmission efficiency of a torque converter according to the first embodiment of the invention;

FIG. 6 is a diagram showing a relation between energy input to a shifting mechanism and a heat generation amount in the shifting mechanism according to the first embodiment of the invention;

FIG. 7 is a diagram showing a relation between the heat generation amount and a lubricant amount in the shifting mechanism according to the first embodiment of the invention;

FIG. 8 is a flow chart showing a procedure of processing performed by a lubricant amount control apparatus according to the first embodiment of the invention;

FIG. 9 is a diagram showing a relation between a temperature and a viscosity of lubricant supplied by the lubricant amount control apparatus shown in FIG. 1;

FIG. 10 is a diagram showing a relation between a temperature and an amount of the lubricant supplied by the lubricant amount control apparatus shown in FIG. 1; and

FIG. 11 is a flow chart showing a procedure of processing performed by a lubricant amount control apparatus according to a second embodiment of the invention.

### DETAILED DESCRIPTION OF THE PREFERRED EMBODIMENTS

In the following description and the accompanying drawings, the present invention will be described in more detail in terms of exemplary embodiments.

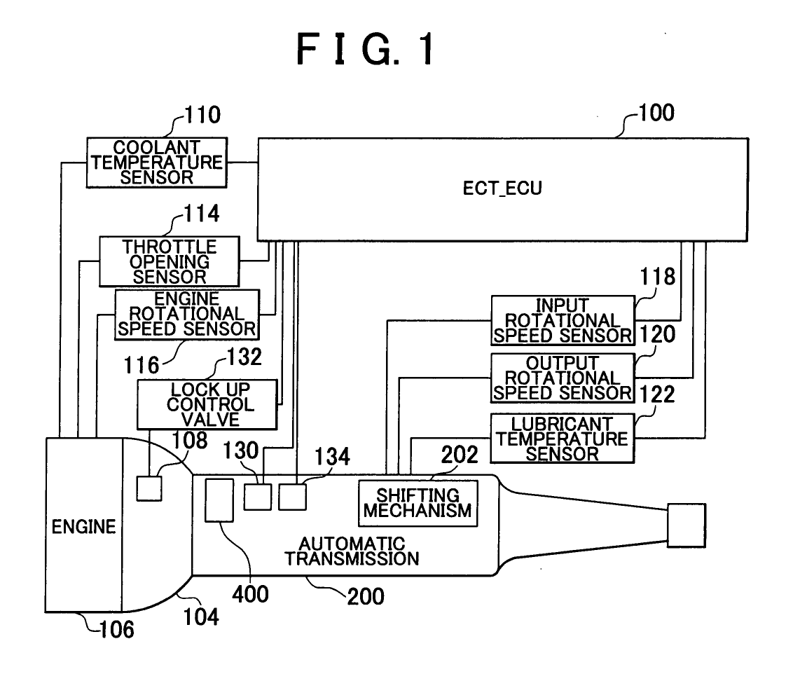

Hereinafter, a first embodiment of the invention will be described. FIG. 1 is a control block diagram showing a lubricant amount control apparatus according to the first embodiment of the invention. A vehicle in which this apparatus is mounted includes an engine 106, a torque converter 104, an automatic transmission 200, an electronically controlled automatic transmission-electronic control unit (hereinafter, referred to as an ECT-ECU) 100, and sensors which are connected to the ECT-ECU 100. The automatic transmission 200 includes an oil pump 400, a pressure adjusting valve 130, a linear solenoid valve 134, and a shifting mechanism 202. They are connected via a lubrication circuit, which will be described later.

In the engine 106, a coolant sensor 110, a throttle opening sensor 114, and an engine rotational speed sensor 116 are provided. In the automatic transmission 200, an input rotational speed sensor 118, an output rotational speed sensor 120, and a lubricant temperature sensor 122 are provided.

The ECT-ECU 100 receives signals from the throttle opening sensor 114, the engine rotational speed sensor 116, the input rotational sensor 118, the output rotational speed sensor 120, and the lubricant temperature sensor 122.

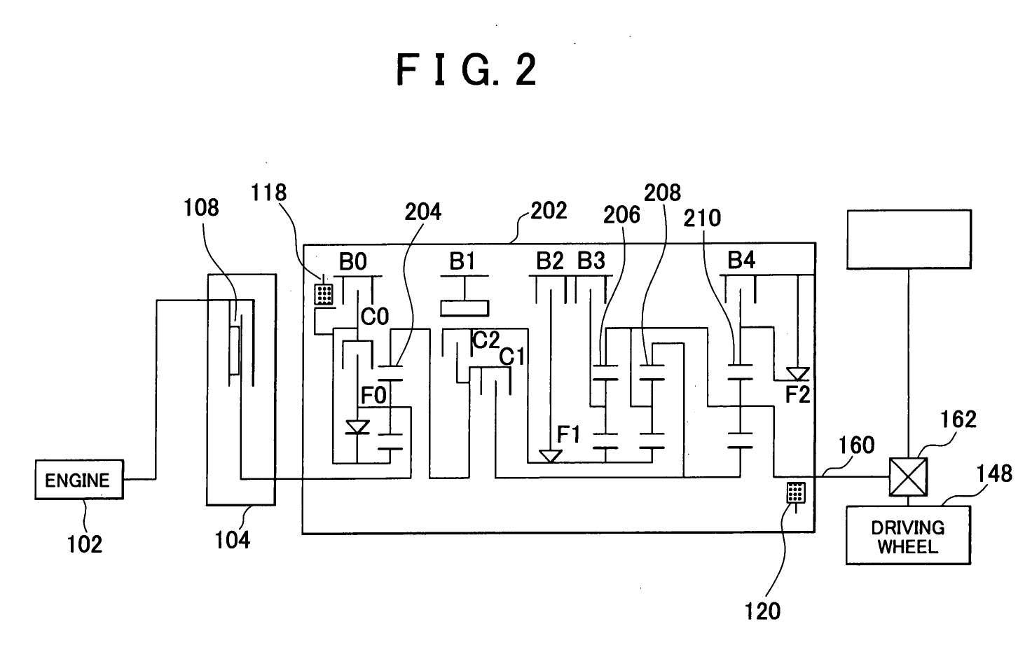

FIG. 2 is a diagram showing a structure of a drive train of the vehicle including the automatic transmission according to the embodiment of the invention. Referring to FIG. 2, output torque of the engine 102 is transmitted to the shifting mechanism 202 by the torque converter 104. The shifting mechanism 202 includes plural friction engagement elements (B0, C0, and the like), gears (gears 204 to 210) and bearings (not shown). An engagement state of each of the friction engagement elements is switched such that a predetermined shift speed is achieved. The predetermined shift speed is transmitted to an output shaft 160 as torque. The gears 204 to 210 are rotated according to the achieved shift speed.

When the shifting mechanism 202 thus configured transmits energy, energy loss occurs in the friction engagement element, the gear, the bearing, or the like (hereinafter, referred to as “a rotation element”). In other words, if slip occurs in the rotation element, energy corresponding to the slip is not output from the automatic transmission 200 as rotation energy. Therefore, heat is generated in the rotation element.

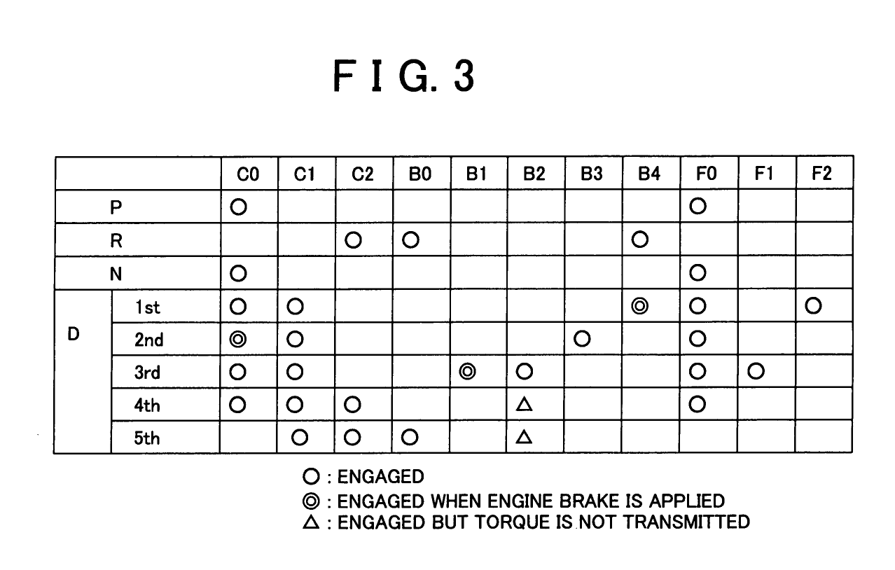

FIG. 3 is an operation table of engagement elements included in the automatic transmission according to the embodiment of the invention. “C0” to “C2” and “B0” to “B4” are friction engagement elements. A circle indicates that an engagement element is in an engagement state. The torque input to the automatic transmission 200 is transmitted via these engagement elements. A double circle indicates that a friction engagement element is in an engagement state when an engine brake is applied. A triangle indicates that a friction engagement element is engaged, but torque is not transmitted.

For example, when a first shift speed is achieved in the vehicle, torque input to the friction engagement elements “C0” and “C1” is transmitted to the output shaft of the automatic transmission 200. In this case, when torque loss occurs, heat is generated in the friction engagement elements “C0” and “C1”.

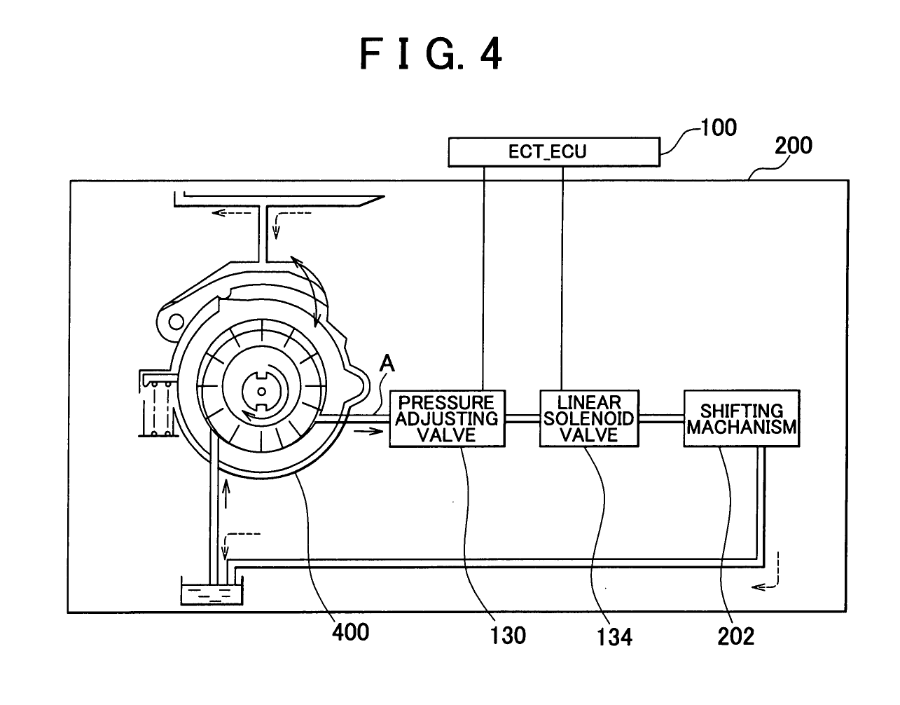

Referring to FIG. 4, the lubrication circuit which supplies lubricant to the shifting mechanism according to the embodiment of the invention will be described. The ECT-ECU 100 controls a hydraulic pressure of the lubricant discharged from the oil pump 400 by outputting a signal to the pressure adjusting valve 130. The ECT-ECU 100 controls the supply amount of lubricant supplied to the shifting mechanism 202 by outputting a signal to the linear solenoid valve 134. A device which controls the lubricant is not limited to the linear solenoid valve 134. For example, an ON-OFF solenoid valve or a variable orifice may be employed. The gears 204 to 210 (shown in FIG. 2) or the bearings (not shown) included in the shifting mechanism 202 are cooled by the lubricant, the supply amount of which is controlled in the above-mentioned manner.

Also, the oil pump 400 is not limited to a specific type of pump. A capacity switching pump in which a discharge pressure or a discharge amount can be switched (for example, a vane pump) may be employed. By using such a pump, it is possible to control the lubricant amount supplied to the shifting mechanism 202 more strictly.

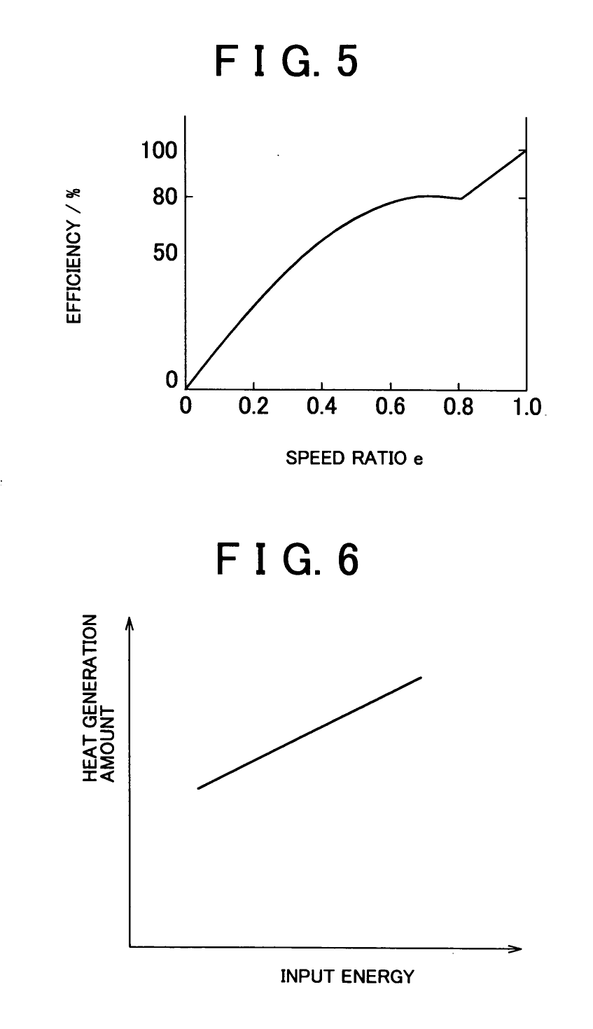

Referring to FIG. 5, characteristics of the torque converter 104 according to the embodiment of the invention will be described. A speed ratio e shown in a horizontal axis shows a ratio between the input rotational speed and the output rotational speed of the torque converter 104. When the torque converter 104 is in a lock up state, the speed ratio is 1. In other words, the input rotational speed and the output rotational speed of the torque converter 104 are the same. At this time, transmission efficiency with which torque is transmitted by the torque converter 104 is 100%, and energy loss does not occur. When the transmission efficiency is less than 100%, heat is generated due to torque loss, and a temperature of the torque converter 104 is increased.

Referring to FIG. 6, a relation between energy input to the automatic transmission 200 and a heat generation amount in the automatic transmission 200 according to the embodiment of the invention will be described.

FIG. 6 shows that the heat generation amount in the automatic transmission 200 is proportional to the energy input to the automatic transmission 200. The heat generation amount corresponds to the energy loss in the automatic transmission 200. When the energy loss is proportional to the input energy, the heat generation amount is proportional to the input energy, as shown in FIG. 6.

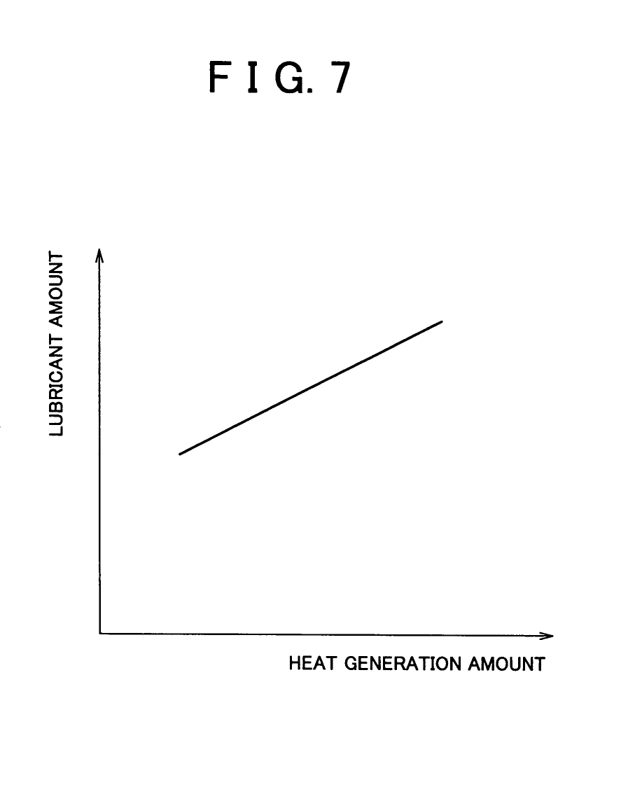

FIG. 7 shows a relation between the heat generation amount and the lubricant amount in the shifting mechanism 202 according to the embodiment of the invention. This relation may be stored in the ECT-ECU 100 in advance. Alternatively, the lubricant amount may be calculated when the operating state of the automatic transmission 200 is detected.

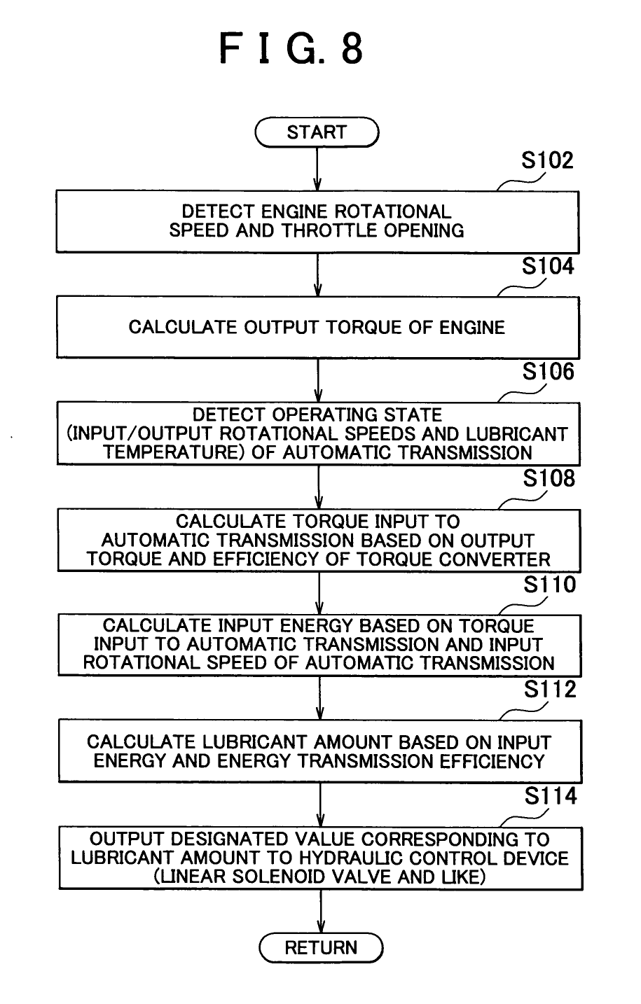

Referring to a flow chart in FIG. 8, a procedure of processing performed by the lubricant amount control apparatus according to the embodiment of the invention will be described.

In step S102, the ECT-ECU 100 detects the rotational speed and the throttle opening of the engine 106.

In step S1104, the ECT-ECU 100 calculates the output torque of the engine 106 based on the input signals from the sensors. This calculation is performed, for example, based on the throttle opening, an intake air amount or a fuel injection amount.

In step S1106, the ECT-ECU 100 detects the operating state of the automatic transmission 200 (for example, the input rotational speed, the output rotational speed, and the lubricant temperature) based on the input signals from the sensors.

In step S108, the ECT-ECU 100 calculates torque input to the automatic transmission 200 based on the output torque of the engine 106 that is calculated in step S1104, and the efficiency of the torque converter 104. The efficiency of the torque converter 104 is calculated based on the speed ratio of the torque converter 104 (shown in FIG. 5), that is, based on the rotational speed of the engine 106 and the input rotational speed of the automatic transmission 200 (a turbine rotational speed of the torque converter 104).

In step S 110, the ECT-ECU 100 calculates the energy input to the automatic transmission 200 based on the torque input to the automatic transmission 200 and the input rotational speed of the automatic transmission 200.

In step S 12, the ECT-ECU 100 calculates the appropriate lubricant amount based on the calculated input energy and the energy transmission efficiency of the shifting mechanism 202. In other words, the heat generation amount in the automatic transmission 200 is calculated based on the input energy. This calculation is performed based on the relation shown in FIG. 6. The lubricant amount is calculated based on the heat generation amount. This calculation is performed based on the relation shown in FIG. 7. The transmission efficiency may be set to an efficiency calculated in advance, or the transmission efficiency may be corrected based on the operating state of the automatic transmission 200 (for example, the lubricant temperature). Alternatively, the lubricant amount may be corrected based on the operating state of the automatic transmission 200.

In step S114, the ECT-ECU 100 outputs, to the linear solenoid valve 134, a designated value (for example, designated current) corresponding to the calculated lubricant amount. The linear solenoid valve 134 controls the discharge pressure of the lubricant based on the designated value. The lubricant is supplied to the gears 204 to 210, the bearings, or the like.

An operation of the lubricant amount control apparatus according to the embodiment of the invention will be described. The operation is performed based on the above-mentioned structure and flow chart.

First, a case where the vehicle is running at a constant speed will be described. When the engine rotational speed and the throttle opening are detected while the vehicle is running (S102), the output torque of the engine 106 is calculated (S104). When the input/output rotational speeds of the automatic transmission 200 and the lubricant temperature are detected (S106), the torque input to the automatic transmission 200 is calculated based on the output torque of the engine 106 and the transmission efficiency of the torque converter 104 (S108).

The energy input to the automatic transmission 200 is calculated based on the calculated input torque and the detected input rotational speed (S110). The lubricant amount supplied to the shifting mechanism 202 is calculated based on the input energy and energy transmission efficiency in the shifting mechanism 202 (S112). The designated value corresponding to the lubricant amount is output to the linear solenoid valve 134 (S114). The supply amount of lubricant is adjusted by the linear solenoid valve 134, and the adjusted amount of lubricant is supplied to the shifting mechanism 202.

Subsequently, a case where the vehicle is running under a high load will be described. When the driver depresses an accelerator pedal after the vehicle is running at a constant speed, and the output of the engine 106 is increased, the increased rotational speed of the engine 106 and the throttle opening are detected (S102), and the output torque of the engine 106 is calculated. The operating state of the automatic transmission 200 is detected (S106), and the input torque of the automatic transmission 200 is calculated (S1108). Then, the input energy is calculated (S110).

The lubricant amount during running under a high load is calculated based on the input energy (S112), and then the lubricating device supplies the lubricant to the shifting mechanism 202 based on the calculated amount. In other words, a larger amount of lubricant is supplied as compared with the case where the vehicle is running at a constant speed. When the driver returns the accelerator pedal after the vehicle is accelerated, the lubricant amount corresponding to the running state at this time is calculated, and the calculated amount of lubricant is supplied to the shifting mechanism 202.

Thus, according to the lubricant amount control apparatus in the embodiment of the invention, the appropriate lubricant amount can be calculated based on the energy input to the automatic transmission 200. Therefore, the lubricant amount in the automatic transmission 200 can be made appropriate. When the automatic transmission 200 is lubricated in this manner, it is possible to prevent a reduction in the life span of the component of the power transmission mechanism, such as the friction engaging element or the bearing. Also, an unnecessarily excessive amount of lubricant is not supplied, driving of the oil pump can be suppressed. As a result, it is possible to provide the lubricant amount control apparatus which can make the lubricant amount appropriate based on the energy input to the power transmission mechanism.

In the embodiment, the input energy is proportional to the heat generation amount (FIG. 6). However, it is not necessary that the input energy be proportional to the heat generation amount (a rate of change in the heat generation amount with respect to the input energy be constant) in all regions. In other words, when the relation between the input energy and the heat generation amount is represented by a non-linear line (i.e., when the rate of change in the heat generation amount changes), the non-linear line may be made approximate to a straight line by interpolation such that the proportionality relation can be obtained.

The supply amount of lubricant supplied to the automatic transmission 200 may be obtained by correcting a reference amount shown in FIG. 7. For example, the lubricant amount may be corrected based on the operating state of the automatic transmission 200 or the engine 106. Thus, the lubricant amount supplied to the automatic transmission 200 can be made appropriate.

A second embodiment of the embodiment will be described. A lubricant amount control apparatus according to the second embodiment has the same hardware configuration as that of the lubricant amount control apparatus according to the first embodiment. Therefore, detailed description thereof will be omitted.

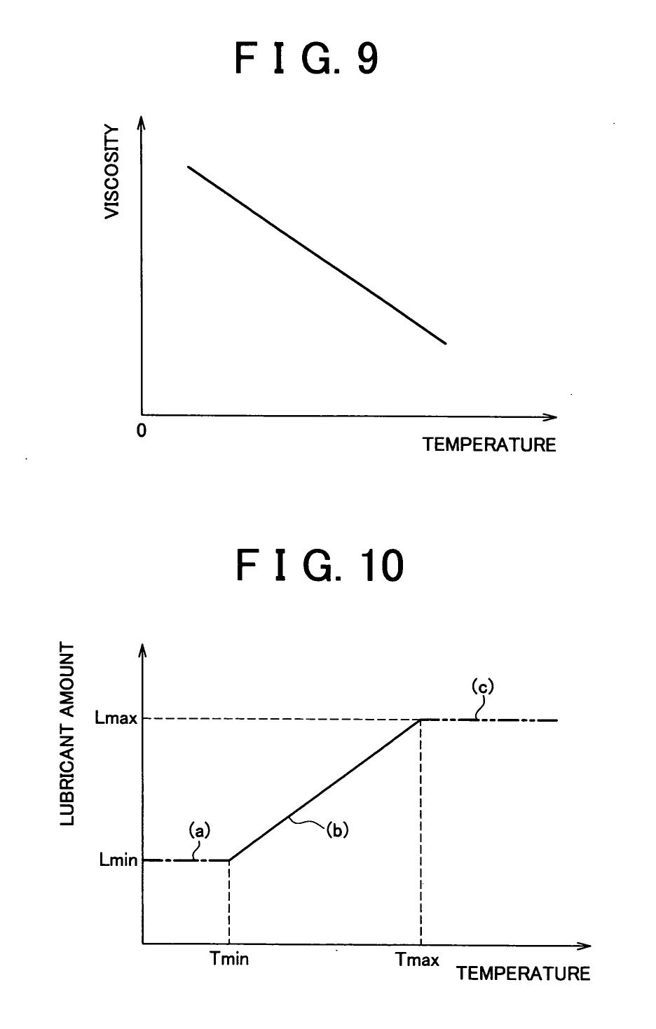

Referring to FIG. 9, a relation between a temperature and a viscosity of lubricant supplied by the lubricant amount control apparatus according to the embodiment will be described. As shown in FIG. 9, the viscosity of the lubricant is high when the lubricant temperature is low, and is low when the lubricant temperature is high. Accordingly, when the lubricant temperature is low, the operation efficiency of the automatic transmission 200 may be decreased due to the viscous resistance of the lubricant. Meanwhile, since an oil film forming property of the lubricant is decreased when the lubricant temperature is high, a state of a friction surface of the component of the automatic transmission 200 is changed from a fluid film lubrication state to a boundary lubrication state, which may cause seizure.

Referring to FIG. 10, a relation between a temperature and an amount of the lubricant when input energy is constant will be described. This relation is stored in the ECT-ECU 100 in advance, for example, as map information by input energy region.

As shown in FIG. 10, when the lubricant temperature is equal to or lower than a temperature Tmin, a required lubricant amount is Lmin (as shown by a dashed line (a)). The lubricant amount Lmin is a minimum lubricant amount that is required for lubricating the automatic transmission 200. In other words, since the automatic transmission 200 does not need to be cooled by the lubricant when the temperature of the automatic transmission 200 is low, it is necessary to supply only the lubricant amount required (i.e., the lubricant amount Lmin) for preventing, for example, the seizure of a rotating portion of the automatic transmission 200.

When the lubricant temperature is in a range from the temperature Tmin to the temperature Tmax, the vehicle is normally running. In this case, an oil cooler (not shown) is also normally operated, and the lubricant is appropriately cooled. Therefore, the lubricant amount in a range from the amount Lmin to the amount Lmax (as shown by a straight line (b)) is supplied to the automatic transmission 200.

When the lubricant temperature is equal to or higher than a temperature Tmax, for example, it is considered that the oil cooler or the like in the lubrication circuit is in an abnormal state. In this case, the maximum lubricant amount that the oil pump 400 can discharge (as shown by a chain double-dashed line (c)) is supplied to the automatic transmission 200 in order to delay seizure of the rotating portion or the other damage as much as possible.

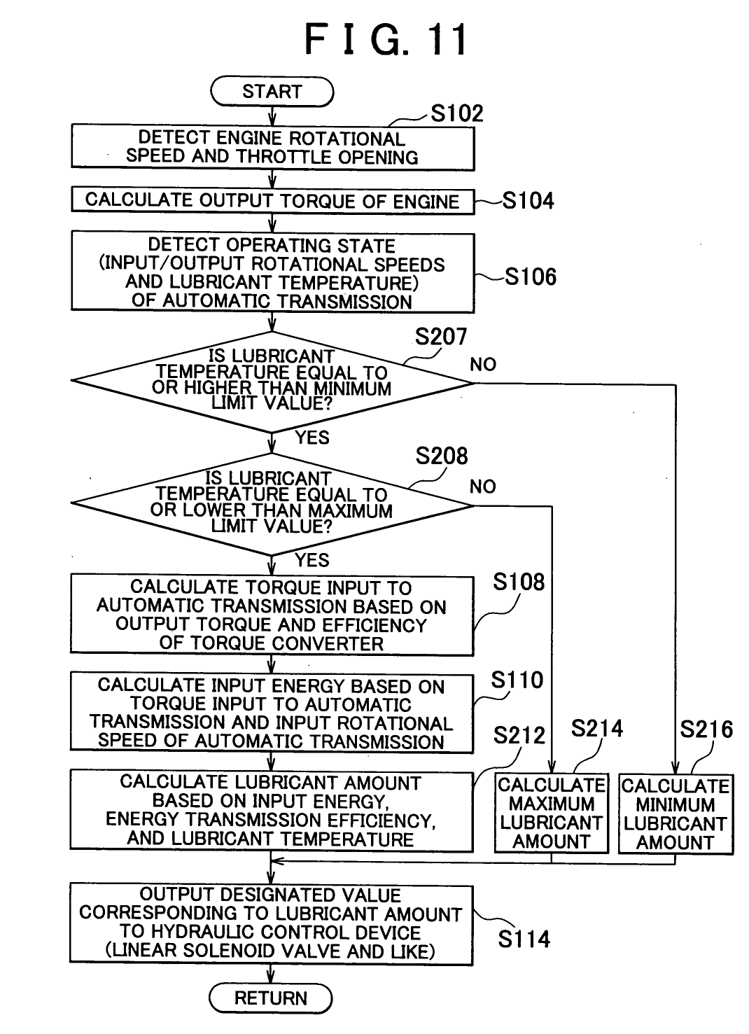

Referring to FIG. 11, a control structure of a program performed by the lubricant amount control apparatus according to the embodiment will be described. In a flow chart shown in FIG. 11, the same processes as in the flow chart shown in FIG. 8 are denoted by the same step numbers. Since the same processes are performed in the steps denoted by the same numbers, description thereof will be omitted.

In step S207, the ECT-ECU 100 determines whether or not the lubricant temperature is equal to or higher than the minimum limit value. When it is determined that the lubricant temperature is equal to or higher than the minimum limit value (i.e., an affirmative determination is made in step S207), the process proceeds to step S208. When it is determined that the lubricant temperature is lower than the minimum limit value (i.e., a negative determination is made in step S207), the process proceeds to S216.

In step S208, the ECT-ECU 100 determines whether or not the lubricant temperature is equal to or lower than the maximum limit value. When it is determined that the lubricant temperature is equal to or lower than the maximum limit value (i.e., an affirmative determination is made in step S208), the process proceeds to step S108. On the other hand, when it is determined that the lubricant temperature is higher than the maximum limit value (i.e., a negative determination is made in step S208), the process proceeds to step S214.

In step S212, the ECT-ECU 100 calculates the lubricant amount based on the input energy, the energy transmission efficiency, and the lubricant temperature. This calculation is made based on map information composed of the input energy, the lubricant temperature, and the lubricant amount.

In step S214, the ECT-ECU 100 calculates the maximum lubricant amount. The maximum lubricant amount is the maximum amount of the lubricant that the oil pump 400 can supply. This maximum lubricant amount is stored in the ECT-ECU 100 in advance.

In step S216, the ECT-ECU 100 calculates the minimum lubricant amount. The minimum lubricant amount is the minimum amount of lubricant that is required for preventing, for example, seizure of the operating portion of the automatic transmission. The minimum lubricant amount is stored in the ECT-ECU 100 in advance.

An operation of the lubricant amount control apparatus according to the embodiment of the invention will be described. The operation is performed based on the above-mentioned structure and flow chart. Each of cases where the lubricant temperature is normal, low, and high will be described. The normal temperature is a lubricant temperature that is detected when the vehicle is normally running. The low temperature is a lubricant temperature that is detected when the vehicle starts running. The high temperature is a lubricant temperature that is detected when the lubricant is not appropriately cooled due to an abnormal state of the oil cooler or the like, or when the engine 104 or the shifting mechanism 202 is in an abnormal state. Description of the same operation as in the first embodiment will be omitted.

A case where the lubricant temperature is normal will be described. An operating state of the automatic transmission 200 is detected while the vehicle is running (S106). When the lubricant temperature is equal to or higher than the minimum limit value (i.e., an affirmative determination is made in step S207), and is equal to or lower than the maximum limit value (i.e., an affirmative determination is made in step S208), the torque input to the automatic transmission 200 is calculated (S108). The energy input to the automatic transmission 200 is calculated (S110), and then the lubricant amount is calculated based on the input energy, energy transmission efficiency, and the lubricant temperature (S212). The designated value corresponding to the calculated lubricant amount is output to the linear solenoid valve 134 (S114). Then, the calculated amount of lubricant is supplied to the automatic transmission 200.

Subsequently, a case where the lubricant temperature is low will be described. When the engine 104 is started, the operating state of the automatic transmission 200 is detected (S106). When it is determined that the lubricant temperature is lower than the minimum limit value (i.e., a negative determination is made in step S207), the minimum lubricant amount supplied to the automatic transmission 200 is calculated (S216). The designated value corresponding to the lubricant amount is output to the linear solenoid valve 134 (S114). Then, the minimum amount of lubricant is supplied to the automatic transmission 200.

Subsequently, a case where the lubricant temperature is high will be described. When the oil cooler has a failure while the vehicle is running, the lubricant is not sufficiently cooled, and the lubricant temperature is increased. In this case, when the lubricant temperature is detected (S1106), it is determined that the lubricant temperature is equal to or higher than the minimum limit value (i.e., an affirmative determination is made in step S207), and is higher than the maximum limit value (i.e., a negative determination is made in step S208). Therefore, the maximum lubricant amount is calculated (S214). The designated value corresponding to the lubricant amount is output to the linear solenoid valve 134 (S114). Then, the maximum amount of lubricant that the oil pump 400 can discharge is supplied to the automatic transmission 200.

Thus, according to the lubricant amount control apparatus in the embodiment, the appropriate lubricant can be calculated based on the energy input to the automatic transmission 200 and the lubricant temperature. Therefore, the automatic transmission 200 can be efficiently lubricated. With this configuration, since the automatic transmission 200 does not need to be cooled when the lubricant temperature is low, only the lubricant amount required for lubricating the automatic transmission 200 is supplied. Accordingly, it is possible to suppress power loss of the oil pump 400 as compared to the case where the unnecessarily excessive amount of lubricant having large viscous resistance is supplied. Also, when the lubricant temperature is high, the maximum amount of lubricant that the oil pump 400 can discharge is supplied. Therefore, it is possible to delay occurrence of damage such as seizure of the rotation element of the automatic transmission 200 due to decreases in properties of the lubricant including the oil film forming property. As a result, it is possible to provide the lubricant amount control apparatus which can make the lubricant amount in the power transmission mechanism appropriate based on the energy input to the power transmission mechanism and the lubricant temperature.

In the lubricant amount control apparatus according to the embodiment, the lubricant amount that is calculated when the lubricant temperature is detected may be stored in the memory or the like. In this manner, it is possible to correct the lubricant amount that is calculated based on the input energy and the lubricant temperature. Therefore, accuracy of calculating the lubricant amount is improved, and the automatic transmission 200 can be efficiently lubricated.

In the embodiment, the relation between the lubricant temperature and the lubricant amount when the input energy is constant is stored in advance in the ECT-ECU 100. Instead, a relation between the input energy and the lubricant amount when the lubricant temperature is constant may be stored in advance in the ECT-ECU 100. In other words, an appropriate relation can be stored as map information according to a range of the input energy and a range of the lubricant temperature. Thus, it is possible to suppress an increase in data to be stored in advance, and to decrease a time required for calculating the lubricant amount.

When the invention has been described with reference to exemplary embodiments thereof, it is to be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

What is claimed is:

1. A lubricant amount control apparatus comprising:
an input energy calculating device which calculates energy input to a power transmission mechanism;
a supply amount calculating device which calculates a supply amount of lubricant based on the input energy; and
a controller which controls a lubricating device for supplying lubricant such that the calculated supply amount of lubricant is supplied to the power transmission mechanism.

2. The lubricant amount control apparatus according to claim 1, wherein the supply amount increases as the input energy increases.

3. The lubricant amount control apparatus according to claim 1, wherein the power transmission mechanism is a transmission including a fluid coupling.

4. The lubricant amount control apparatus according to claim 1, further comprising:
an input torque calculating device which calculates torque input to the power transmission mechanism;
an operating state detecting device which detects an operating state of the power transmission mechanism, wherein the input energy calculating device calculates the input energy based on the calculated input torque and the detected operating state.

5. The lubricant amount control apparatus according to claim 4, wherein the operating state is an input rotational speed of the power transmission mechanism.

6. The lubricant amount control apparatus according to claim 4, wherein the power transmission mechanism is a transmission including a fluid coupling, and the operating state is a heat generation state of the fluid coupling.

7. The lubricant amount control apparatus according to claim 1, further comprising a lubricant temperature detecting device which detects a lubricant temperature, wherein the supply amount calculating device calculates the supply amount of lubricant based on the input energy and the lubricant temperature.

8. The lubricant amount control apparatus according to claim 7, further comprising:
an input torque calculating device which calculates torque input to the power transmission mechanism;
an operating state detecting device which detects an operating state of the power transmission mechanism, wherein the input energy calculating device calculates the input energy based on the calculated input torque and the detected operating state.

9. The lubricant amount control apparatus according to claim 7, wherein the supply amount calculating device calculates the supply amount based on the input energy and the lubricant temperature when the lubricant temperature is in a predetermined range.

10. The lubricant amount control apparatus according to claim 7, wherein the supply amount calculating device calculates the supply amount such that the supply amount becomes a predetermined amount when the lubricant temperature is not in the predetermined range.

11. A lubricant amount control method comprising the steps of:
calculating energy input to a power transmission mechanism of a vehicle;
calculating a supply amount of lubricant based on the input energy; and
controlling a lubricating device for supplying lubricant such that the calculated supply amount of lubricant is supplied to the power transmission mechanism.

12. The lubricant amount control method according to claim 11, wherein the supply amount increases as the input energy increases.

13. The lubricant amount control method according to claim 11, wherein the power transmission mechanism is a transmission including a fluid coupling.

14. The lubricant amount control method according to claim 11, further comprising the steps of:
calculating torque input to the power transmission mechanism; and
detecting an operating state of the power transmission mechanism, wherein the input energy is calculated based on the calculated input torque and the detected operating state in the step of calculating the input energy.

15. The lubricant amount control method according to claim 14, wherein the operating state is an input rotational speed of the power transmission mechanism.

16. The lubricant amount control method according to claim 14, wherein the power transmission mechanism is a transmission including a fluid coupling, and the operating state is a heat generation state of the fluid coupling.

17. The lubricant amount control method according to claim 11, further comprising the step of detecting a lubricant temperature, wherein the supply amount is calculated based on the input energy and the lubricant temperature in the step of calculating the supply amount of lubricant.

18. The lubricant amount control method according to claim 17, further comprising the steps of:
calculating torque input to the power transmission mechanism;
detecting an operating state of the power transmission mechanism, wherein the input energy is calculated based on the calculated input torque and the detected operating state in the step of calculating the input energy.

19. The lubricant amount control method according to claim 17, wherein the supply amount is calculated based on the input energy and the lubricant temperature in the step of calculating the supply amount when the lubricant temperature is in a predetermined range.

20. The lubricant amount control method according to claim 17, wherein the supply amount is calculated such that the supply amount becomes a predetermined amount in the step of calculating the supply amount when the lubricant temperature is not in a predetermined range.
